(19) United States
(12) Patent Application Publication
(10) Pub. No.: US 2020/0094830 A1
(43) Pub. Date: Mar. 26, 2020

(54) Vehicle Motion Control Apparatus, Vehicle Motion Control Method, and Vehicle Motion Control System

(71) Applicant: Hitachi Automotive Systems, Ltd., Hitachinaka-shi, Ibaraki (JP)

(72) Inventors: Hiroshi ITO, Isehara-shi, Kanagawa (JP); Kentaro UENO, Atsugi-shi, Kanagawa (JP); Hiroki SUGAWARA, Sagamihara-shi, Kanagawa (JP)

(21) Appl. No.: 16/618,652

(22) PCT Filed: May 23, 2018
(86) PCT No.: PCT/JP2018/019790

§ 371 Date: Dec. 2, 2019

(30) Foreign Application Priority Data
Jun. 13, 2017 (JP) 2017-115681

(51) Int. Cl. B60W 30/165; B60W 30/10; B60W 30/16; B60W 30/18; G05D 1/02

(52) U.S. Cl. CPC B60W 30/165; B60W 30/10; B60W 2750/308; B60W 30/18145; G05D 1/0291; B60W 30/162

(57) ABSTRACT

Provided is a vehicle motion control apparatus of a following vehicle that is non-mechanically linked to a preceding vehicle and thus capable of performing follow-up cruising, comprising a target trajectory acquisition portion configured to acquire a target trajectory for enabling the following vehicle to follow a running trajectory of the preceding vehicle, the target trajectory being generated according to acquired information regarding the preceding vehicle, and an actuator control output portion configured to output to a control portion of an actuator which is associated with the steering, braking, and driving of the following vehicle, a command to follow the preceding vehicle with a closest approach distance from the preceding vehicle maintained at a preset distance according to the target trajectory acquired by the target trajectory acquisition portion.

### TECHNICAL FIELD

The invention relates to a vehicle motion control apparatus, method, and system for following a preceding vehicle.

### BACKGROUND ART

Patent Literature 1 is one of the examples of background art of the technical field relating to automatic cruise control for a vehicle that is electronically linked to and follows a preceding vehicle. Patent Literature 1 discloses that a following vehicle receives information indicating driving conditions including the vehicle speed and acceleration rate of a preceding vehicle, information indicating a throttle position, a steering angle, and operation amounts including a brake operation amount, and information indicating vehicle specifications including vehicle weight, engine output characteristics, etc., and thus that the following vehicle is capable of performing follow-up control by the same operation as the operation aimed towards the preceding vehicle without having to wait for the driving conditions to change as a result of control on the preceding vehicle.

### CITATION LIST

### Patent Literature

PTL 1: Japanese Unexamined Patent Application Publication (Kokai) No. 5-170008

### SUMMARY OF INVENTION

### Technical Problem

Patent Literature 1 states that, when an inter-vehicle distance obtained by feedforward control fluctuates against a predetermined inter-vehicle distance as in a case where a third vehicle cuts in between an object preceding vehicle and an ego vehicle, the ego vehicle can be controlled to recover the predetermined inter-vehicle distance. Nevertheless, a cut-in by another vehicle necessitates a sudden braking of the following vehicle and causes a danger, and also might hinder the following vehicle from continuing automatic follow-up cruising. At the same time, the following vehicle has to be equipped with a device for detecting a cut-in vehicle, a device for controlling an inter-vehicle distance to keep distance from the cut-in vehicle, a control device for realigning a line of the vehicles after the cut-in vehicle pulls out of the line, and other like devices. There is another problem that, if someone cuts in between the vehicles while the vehicles are parked, the automatic follow-up cruising cannot be resumed.

In view of the aforementioned problems, the invention provides a vehicle motion control apparatus, a vehicle motion control method, and a vehicle motion control system, which are capable of preventing a third person or object from cutting in between a preceding vehicle and a following vehicle.

### Solution to Problem

The invention is, for example, a vehicle motion control apparatus of a following vehicle that is non-mechanically linked to a preceding vehicle and thus capable of performing follow-up cruising. The apparatus comprises a target trajectory acquisition portion configured to acquire a target trajectory for enabling the following vehicle to follow a running trajectory of the preceding vehicle, the target trajectory being generated according to acquired information regarding the preceding vehicle, and an actuator control output portion configured to output a command to follow the preceding vehicle with a closest approach distance from the preceding vehicle maintained at a preset distance according to the target trajectory acquired by the target trajectory acquisition portion to a control portion of an actuator which is associated with steering, braking, and driving of the following vehicle.

One embodiment of the invention provides the vehicle motion control apparatus, the vehicle motion control method, and the vehicle motion control system, which are capable of preventing a third person or object from cutting in between the preceding vehicle and the following vehicle.

### BRIEF DESCRIPTION OF DRAWINGS

FIG. 1 is a diagram showing a concept of a vehicle motion control system according to an embodiment.

FIG. 2 explain relationship of an inter-vehicle distance and a turning angle formed during vehicle travel according to the embodiment.

FIG. 3 are schematic diagrams showing relationship of a closest approach distance between vehicles and a curvature radius of a turn according to the embodiment.

FIG. 4 is a schematic graph showing relationship of vehicle speed and the closest approach distance between the vehicles according to the embodiment.

FIG. 5 is a configuration block diagram of the vehicle motion control system according to the embodiment.

FIG. 6 is an explanatory view of acceleration/deceleration control according to the embodiment.

### DESCRIPTION OF EMBODIMENTS

The following description explains an embodiment of the invention in detail with reference to the attached drawings.

### EMBODIMENT

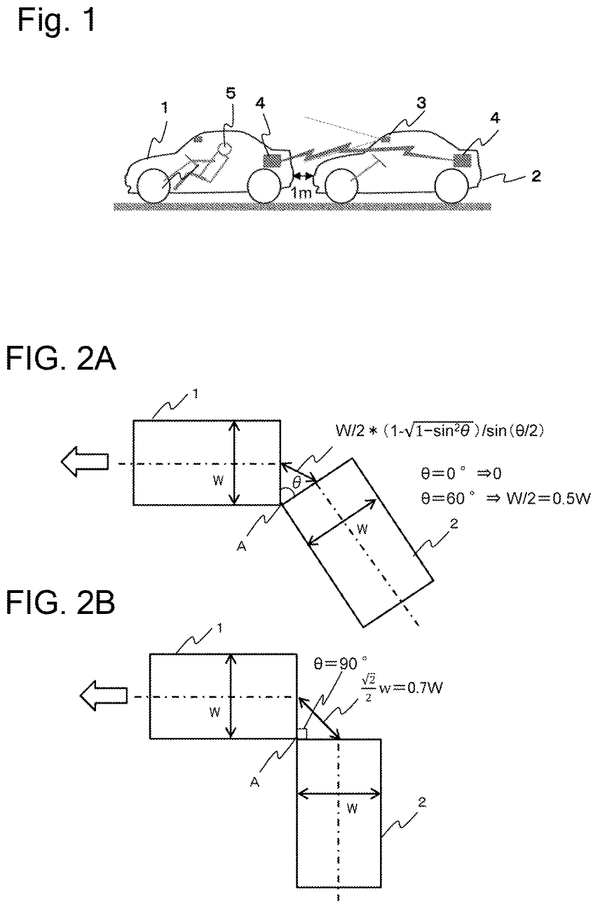

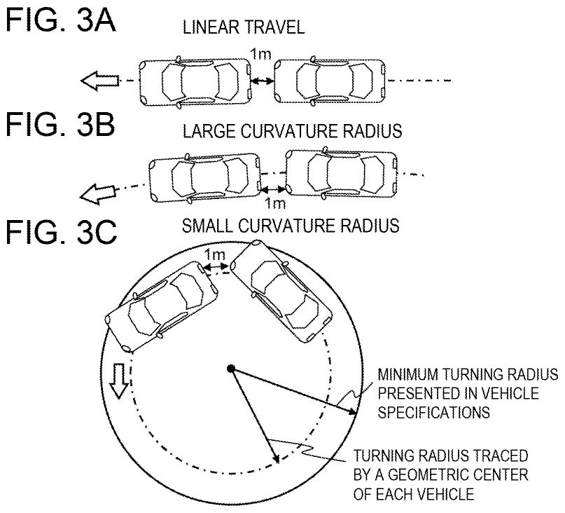

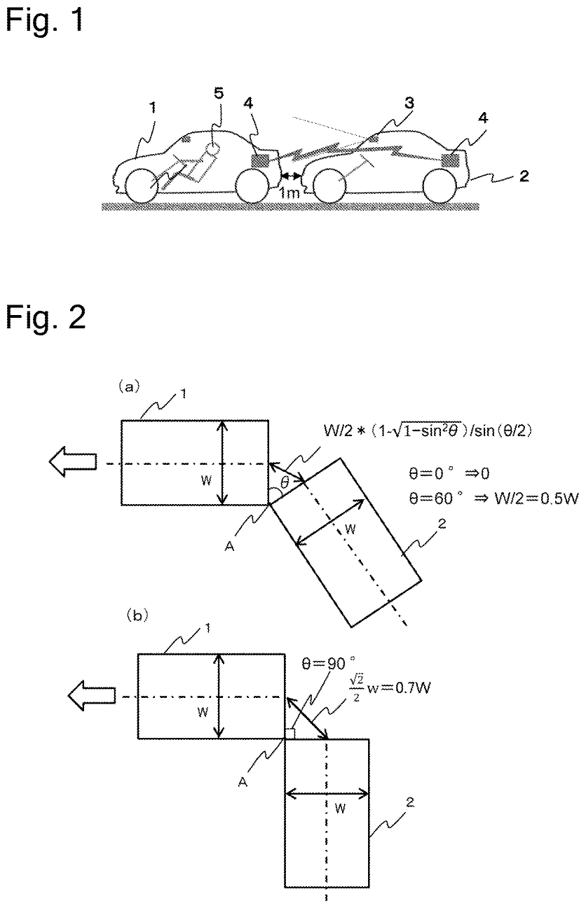

FIG. 1 is a diagram showing a concept of a vehicle motion control system according to an embodiment. In FIG. 1, numeral 1 represents a preceding vehicle, and 2 represents a following vehicle that follows the preceding vehicle 1. The following vehicle 2 is equipped with a preceding vehicle recognition sensor 3 and a vehicle-to-vehicle communication device 4. The following vehicle 2 is a vehicle that is electronically linked to the preceding vehicle 1 and follows the preceding vehicle 1 unattendedly. A driver 5 sits in the preceding vehicle 1, and the following vehicle 2 automatically follows an exact locus of the preceding vehicle 1. The following vehicle 2 performs follow-up cruising while a cut-in of another vehicle is prevented by setting the closest approach distance between the preceding vehicle 1 and the following vehicle 2, for example, to 1 meter. If an inter-vehicle distance between the vehicles is set short, there is a possibility that the following vehicle approaches the preceding vehicle, depending on a curvature radius created during vehicle travel, and thus that it is impossible to carry out the same operation as an operation aimed towards the preceding vehicle, making it difficult for the following vehicle to perform the follow-up cruising. This matter will be discussed below with reference to the drawings.

FIG. 2 explain relationship of an inter-vehicle distance and a turning angle formed by vehicle travel. FIG. 2 schematically show the preceding vehicle 1 traveling in a direction of an outlined arrow and the following vehicle 2 following the preceding vehicle 1. In FIG. 2, the preceding vehicle 1 and the following vehicle 2 each have vehicle width W. FIG. 2 show a change in the inter-vehicle distance, which is made according to the turning angle formed by vehicle travel, in a case where the inter-vehicle distance between the preceding vehicle 1 and the following vehicle 2 is distance between geometric centers of the vehicles, that is, distance between a center point of the vehicle width of a rear end of the preceding vehicle 1 and a center point of the vehicle width of a front end of the following vehicle 2, and the preceding vehicle 1 and the following vehicle 2 contact each other at an A point. As illustrated in FIG. 2(a), the inter-vehicle distance along a centerline of the vehicle width in relation to an angle θ formed by the preceding vehicle 1 and the following vehicle 2 during vehicle travel is (W/2)×(1−√(1−sin 2θ))/sin(θ/2). Accordingly, for example, if θ=0°, that is, when the vehicles travel in a linear line, the inter-vehicle distance is zero. If θ=60°, the inter-vehicle distance is 0.5 W. FIG. 2(b) shows a case where θ=90°, and the inter-vehicle distance is 0.7 W. The inter-vehicle distance for avoiding contact between the preceding vehicle 1 and the following vehicle 2 needs to be increased with an increase in the angle θ, that is, with a decrease in the curvature radius and an increase in the turning angle of a turn.

To that end, the embodiment implements such control as to maintain a closest approach distance between the vehicles at distance that is previously set according to vehicle speed without limitation on the curvature radius of a vehicle turn. In other words, the embodiment does not maintain the inter-vehicle distance which is the distance along the centerlines of the vehicle widths, but maintains a fixed closest approach distance between the vehicles as illustrated in FIG. 2. In FIG. 2, the closest approach distance is shown by the A point. The A point indicates distance between a rear left corner of the preceding vehicle and a front left corner of the following vehicle. In FIG. 2, the closest approach distance is zero.

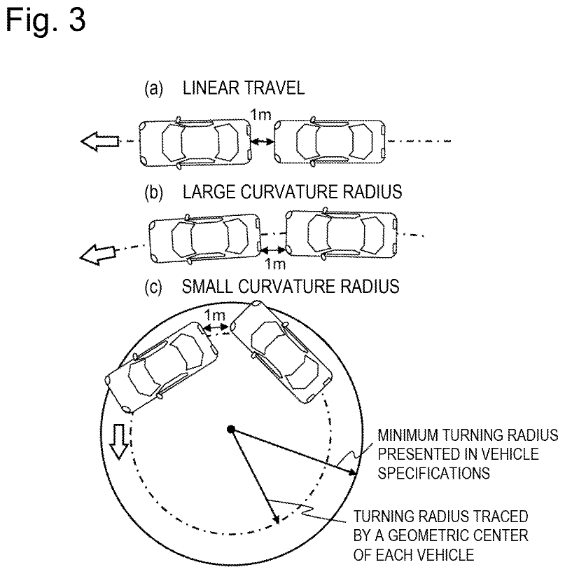

FIG. 3 are schematic diagrams showing relationship of the closest approach distance between the vehicles and the curvature radius of a turn according to the embodiment. FIG. 3(a) shows a case where the vehicles travel in a linear line. The closest approach distance equals the inter-vehicle distance. FIG. 3(b) shows a case where the vehicles travel on a gentle curve with a large curvature radius created during vehicle travel. FIG. 3(c) shows a case where the vehicles travel on a sharp curve with a small curvature radius. FIG. 3 show that the following vehicle is controlled in speed so that the closest approach distance is, for example, 1 meter, regardless of variation in curvature radius. As illustrated in FIG. 3(c), despite the small curvature radius, a trajectory does not result in a shortcut path unlike a case where a tow vehicle physically tows an object. Instead, the following vehicle accurately tracks the trajectory of the preceding vehicle. Taking an inner wheel difference into account, a target trajectory of the following vehicle is set so that the preceding and following vehicles have the same geometric center to enable the following vehicle to trace a route on which the preceding vehicle travels. When the following vehicle is switched to a curved motion during linear follow-up cruising, for example, a vehicle angle formed by the preceding vehicle and the following vehicle is changed. Due to a geometrical relation, the closest approach distance is decreased even if vehicle speed is constant. In view of this, the following vehicle is accelerated or decelerated according to the curvature radius and controlled so that the closest approach distance is fixed. In other words, the following vehicle is controlled to maintain the fixed closest approach distance. Accordingly, for example, if the preceding vehicle travels at a constant vehicle speed but makes turns with various curvature radii, the following vehicle is controlled to be accelerated or decelerated so that the closest approach distance from the preceding vehicle is limited to a preset distance.

Even if the preceding vehicle makes a turn with a small curvature radius, the acceleration/deceleration control enables the following vehicle to perform the follow-up cruising while maintaining the closest approach distance from the preceding vehicle without limitation on the curvature radius of a turn.

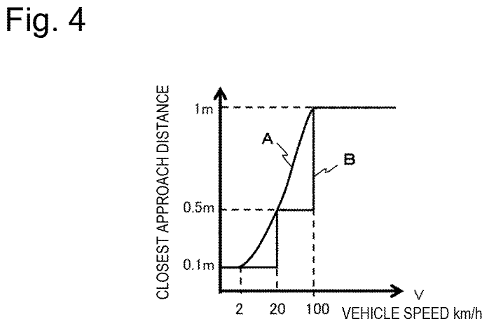

FIG. 4 is a schematic graph showing relationship of the vehicle speed and the closest approach distance between the vehicles according to the embodiment. According to characteristic B in FIG. 4, for example, if the vehicle speed is 100 km or higher, the closest approach distance is set to 1.0 meter which is a distance a motorcycle cannot cut in between the preceding vehicle and the following vehicle. If the vehicle speed is 20 km or higher but lower than 100 km, the closest approach distance is set to 0.5 meter which is a distance a bicycle cannot cut in between the preceding vehicle and the following vehicle. When the vehicle speed is lower than 20 km, the closest approach distance is set to 0.1 meter which is a distance a pedestrian cannot cut in between the preceding vehicle and the following vehicle. The closest approach distance that is thus variable according to the vehicle speed prevents the cut-ins of third persons or objects including vehicles, motorcycles, bicycles, and people in many different situations. In short, the closest approach distance is decreased with a decrease in the speed of the preceding vehicle. Lower vehicle speed allows cut-ins of more objects, from vehicles to motorcycles to bicycles to people. Therefore, if the distance remains the same, cut-ins are more likely to occur. The embodiment prevents the cut-ins by decreasing the closest approach distance as the vehicle speed is decreased. Characteristic A in FIG. 4 indicates the detailed setting of the closest approach distance in responding to vehicle speeds. More cut-ins are prevented by controlling the closest approach distance this way.

The closest approach distance has to be distance that prevents the cut-ins of vehicles at a maximum, so that the closest approach distance may be less than vehicle width.

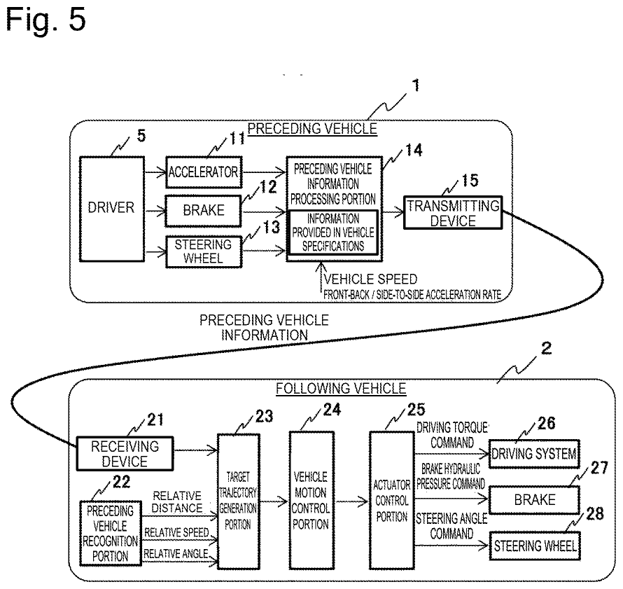

FIG. 5 is a configuration block diagram of the vehicle motion control system according to the embodiment. In FIG. 5, the preceding vehicle 1 comprises a preceding vehicle information processing portion 14 configured to process operation information as to operation amounts of an accelerator 11, a brake 12, and a steering wheel 13, which are operated by a driver 5, and preceding vehicle information including driving condition amount, such as vehicle speed and an acceleration rate, and vehicle specifications. The preceding vehicle 1 includes a transmitting device 15 configured to transmit the preceding vehicle information.

The following vehicle 2 comprises a receiving device 21 configured to receive the preceding vehicle information that is transmitted from the preceding vehicle 1; a preceding vehicle recognition portion 22 configured to acquire preceding vehicle recognition information including relative distance, relative speed, relative angle, and the like with respect to the preceding vehicle 1; a target trajectory generation portion 23 configured to generate a target trajectory for enabling the following vehicle to follow a running trajectory of the preceding vehicle according to the preceding vehicle information that is received and the information of the preceding vehicle recognition portion 22; a vehicle motion control portion 24 configured to calculate a control command to control vehicle motion of an ego vehicle so that the ego vehicle tracks the target trajectory; and an actuator control portion 25 configured to calculate and output a control amount of a drive system 26 including an engine and a drive motor, a brake 27, and a steering wheel 28, which relate to steering, braking, and driving, according to the control command of the vehicle motion control portion 24.

The preceding vehicle recognition portion 22 may acquire the preceding vehicle recognition information through vehicle-to-vehicle communication or through an external environment recognition portion that is a form recognition apparatus, such as a stereo camera and a laser radar.

Although not shown, the vehicle motion control portion 24 comprises a target trajectory acquisition portion configured to acquire the target trajectory generated in the target trajectory generation portion 23, and an actuator control output portion configured to output to the actuator control portion a command to follow the preceding vehicle with the closest approach distance from a preceding vehicle maintained at the preset distance according to the target trajectory acquired by the target trajectory acquisition portion. In other words, regardless of variation in the curvature radius of a turn of the preceding vehicle, the vehicle motion control portion 24 outputs the command to travel with the closest approach distance from the preceding vehicle maintained at the preset distance to the actuator control portion associated with the steering, braking, and driving of the ego vehicle.

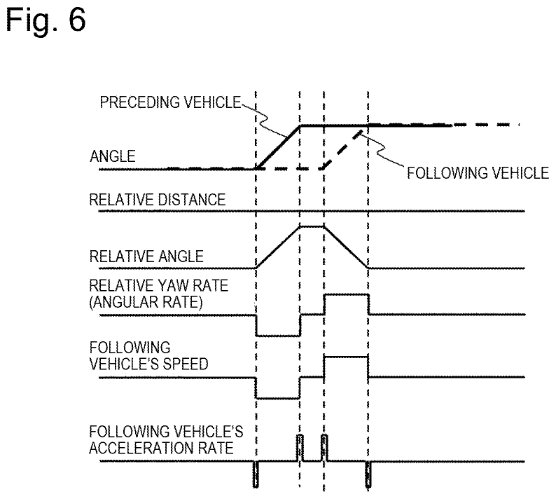

FIG. 6 is an explanatory view of acceleration/deceleration control according to the embodiment. An angle in FIG. 6 shows a change in turning angle of the vehicle when the vehicle is switched from linear to curved motion. A solid line represents the preceding vehicle, and a broken line represents the following vehicle. When traveling on a curve, the following vehicle turns on the curve later than the preceding vehicle and is accelerated or decelerated to maintain the closest approach distance from the preceding vehicle. In FIG. 6, the relative distance shows that the closest approach distance from the preceding vehicle is fixed. The relative angle shows difference of the turning angle between the preceding and following vehicles. The relative yaw rate (angular rate) to the turning angle difference changes as illustrated. An acceleration rate on the following vehicle is controlled as illustrated, thus controlling the speed of the following vehicle.

Although the following vehicle is controlled to be accelerated or decelerated to maintain the fixed closest approach distance as described above, this should not be limitedly interpreted that the closest approach distance is absolutely fixed. On the contrary, the following vehicle is controlled so that the closest approach distance is fixed to the extent that an advantageous effect of the invention can be exerted.

As discussed above, the embodiment relates to the vehicle motion control apparatus of the following vehicle that is non-mechanically linked to the preceding vehicle and thus capable of performing follow-up cruising. The vehicle motion control apparatus comprises the target trajectory acquisition portion configured to acquire the target trajectory for enabling the following vehicle to follow the running trajectory of the preceding vehicle, the target trajectory being generated according to the acquired information regarding the preceding vehicle, and the actuator control output portion configured to output to the control portion of the actuator which is associated with the steering, braking, and driving of the following vehicle, the command to follow the preceding vehicle with the closest approach distance from the preceding vehicle maintained at the preset distance according to the target trajectory acquired by the target trajectory acquisition portion.

The vehicle motion control apparatus of the following vehicle that is non-mechanically linked to the preceding vehicle and thus capable of performing follow-up cruising is configured to implement the acceleration/deceleration control according to the curvature radius of a turn of the preceding vehicle and output the command to travel with the closest approach distance from the preceding vehicle limited to the preset distance to the actuator associated with the steering, braking, and driving of the following vehicle.

The vehicle motion control apparatus of the following vehicle that is non-mechanically linked to the preceding vehicle and thus capable of performing follow-up cruising is configured to output to the actuator associated with the steering, braking, and driving of the following vehicle, the command to travel with the closest approach distance from the preceding vehicle maintained at the preset distance, regardless of variation in the curvature radius of a turn of the preceding vehicle.

A follow-up control system of the following vehicle that is non-mechanically linked to the preceding vehicle and thus capable of performing follow-up cruising comprises a receiving portion configured to receive preceding vehicle information that is transmitted from the preceding vehicle; the external environment recognition portion configured to recognize the preceding vehicle and acquire preceding vehicle recognition information; the target trajectory generation portion configured to generate the target trajectory for enabling the following vehicle to follow the running trajectory of the preceding vehicle according to the preceding vehicle information received by the receiving portion and the preceding vehicle recognition information acquired by the external environment recognition portion; the vehicle motion control portion configured to output the command to travel while implementing the acceleration/deceleration control according to the curvature radius of a turn of the preceding vehicle on the basis of the target trajectory generated by the target trajectory generation portion; and the actuator control output portion configured to input the command outputted by the vehicle motion control portion and output the command to the actuator associated with the steering, braking, and driving.

A vehicle motion control method of a following vehicle that is non-mechanically linked to a preceding vehicle and thus capable of performing follow-up cruising comprises a target trajectory acquisition step configured to acquire a target trajectory for enabling the following vehicle to follow a running trajectory of the preceding vehicle, the target trajectory being generated according to acquired information associated with the preceding vehicle; and an actuator control output step configured to output to a control portion of an actuator which is associated with steering and braking-driving operations of the following vehicle, a command to follow the preceding vehicle with a closest approach distance from the preceding vehicle limited to a preset distance according to the target trajectory acquired by the target trajectory acquisition step.

This makes it possible to provide the vehicle motion control apparatus, the vehicle motion control method, and the vehicle motion control system, which are capable of preventing a third person or object from cutting in between the preceding vehicle and the following vehicle.

The invention is not limited to the foregoing embodiments and includes various modification examples. For example, the embodiments are described in detail to facilitate the understanding of the invention and does not necessarily have to include all the constitutions discussed above. The constitution of one of the embodiments may be partially replaced with or may be incorporated into the constitution of another one of the embodiments. It is also possible to incorporate, cancel or replace the configuration of one of the embodiments into, from or with the configuration of another one of the embodiments.

The present application claims priority under Japanese Patent Application No. 2017-115681 filed on Jun. 13, 2017. The entire disclosure of Japanese Patent Application No. 2017-115681 filed on Jun. 13, 2017 including the description, claims, drawings and abstract, is incorporated herein by reference in its entirety.

### REFERENCE SIGN LIST

1: preceding vehicle, 2: following vehicle, 21: receiving device, 22: preceding vehicle recognition portion, 23: target trajectory generation portion, 24: vehicle motion control portion, 25: actuator control portion

1. A vehicle motion control apparatus of a following vehicle that is non-mechanically linked to a preceding vehicle and thus capable of performing follow-up cruising, the vehicle motion control apparatus comprising:
a target trajectory acquisition portion configured to acquire a target trajectory for enabling the following vehicle to follow a running trajectory of the preceding vehicle, the target trajectory being generated according to acquired information regarding the preceding vehicle; and
an actuator control output portion configured to output to a control portion of an actuator which is associated with steering, braking, and driving of the following vehicle, a command for making the following vehicle follow the preceding vehicle with a closest approach distance between the preceding vehicle and the following vehicle maintained at a preset distance based on the target trajectory acquired by the target trajectory acquisition portion.

2. The vehicle motion control apparatus described in claim 1,
wherein the actuator control output portion is configured to output to the control portion of the actuator the command for making the following vehicle follow the preceding vehicle while maintaining the closest approach distance without limitation on a curvature radius of a turn of the preceding vehicle.

3. The vehicle motion control apparatus described in claim 1,
wherein the closest approach distance is set according to speed of the preceding vehicle.

4. The vehicle motion control apparatus described in claim 3,
wherein the closest approach distance is decreased with a decrease in the speed of the preceding vehicle.

5. The vehicle motion control apparatus described in claim 4,
wherein the closest approach distance is set less than vehicle width of the following vehicle.

6. The vehicle motion control apparatus described in claim 1,
wherein the target trajectory acquisition portion is configured to acquire a target trajectory generated based on a running trajectory traced by a geometric center of the preceding vehicle.

7. The vehicle motion control apparatus described in claim 1,
wherein the actuator control output portion is configured to output to the control portion of the actuator a command to implement acceleration/deceleration control on the following vehicle according to a curvature radius of a turn of the preceding vehicle.

8. The vehicle motion control apparatus described in claim 1,
wherein the actuator control output portion is configured to output a command to implement acceleration/deceleration control according to a relative angle of the preceding vehicle with respect to the following vehicle.

9. A vehicle motion control apparatus of a following vehicle that is non-mechanically linked to a preceding vehicle and thus capable of performing follow-up cruising,
wherein a command to implement acceleration/deceleration control on the following vehicle according to a curvature radius of a turn of the preceding vehicle is outputted to an actuator associated with steering, braking, and driving of the following vehicle, the command being configured to make the following vehicle travel with a closest approach distance from the preceding vehicle limited to a preset distance.

10. The vehicle motion control apparatus described in claim 9,
wherein a command is outputted to an actuator associated with steering, braking, and driving of the following vehicle, the command being configured to implement deceleration control on the following vehicle as a curvature radius of a turn of the preceding vehicle is decreased and thus make the following vehicle travel with a closest approach distance between the preceding vehicle and the following vehicle limited to a preset distance.

11. The vehicle motion control apparatus described in claim 10,
wherein the closest approach distance is set less than vehicle width of the following vehicle.

12. A vehicle motion control apparatus of a following vehicle that is non-mechanically linked to a preceding vehicle and thus capable of performing follow-up cruising,
wherein a command is outputted to an actuator associated with steering, braking, and driving of the following vehicle, the command being configured to make the following vehicle travel with a closest approach distance between the preceding vehicle and the following vehicle maintained at a preset distance, regardless of variation in a curvature radius of a turn of the preceding vehicle.

13. The vehicle motion control apparatus described in claim 12,
wherein the closest approach distance is set less than vehicle width of the following vehicle.

14. A vehicle motion control system of a following vehicle that is non-mechanically linked to a preceding vehicle and thus capable of performing follow-up cruising, the vehicle motion control system comprising:
a receiving portion configured to receive preceding vehicle information that is transmitted from the preceding vehicle;
an external environment recognition portion configured to recognize the preceding vehicle and acquire preceding vehicle recognition information;
a target trajectory generation portion configured to generate a target trajectory for enabling the following vehicle to follow a running trajectory of the preceding vehicle based on the preceding vehicle information received by the receiving portion and the preceding vehicle recognition information acquired by the external environment recognition portion;
a vehicle motion control portion configured to output a command to make the following vehicle travel while acceleration/deceleration control is implemented on the following vehicle according to a curvature radius of a turn of the preceding vehicle based on the target trajectory generated by the target trajectory generation portion; and
an actuator control output portion, into which the command from the vehicle motion control portion is entered, the actuator control output portion being configured to output the command to the actuator associated with the steering, braking, and driving.

15. A vehicle motion control method of a following vehicle that is non-mechanically linked to a preceding vehicle and thus capable of performing follow-up cruising, the vehicle motion control method comprising:
a target trajectory acquisition step configured to acquire a target trajectory for enabling the following vehicle to follow a running trajectory of the preceding vehicle, the target trajectory being generated based on acquired information regarding the preceding vehicle; and
an actuator control output step configured to output to a control portion of an actuator which is associated with steering and braking-driving operations of the following vehicle, a command to follow the preceding vehicle with a closest approach distance between the preceding vehicle and the following vehicle limited to a preset distance based on the target trajectory acquired by the target trajectory acquisition step.
